(19) United States
(12) Patent Application Publication
(10) Pub. No.: US 2025/0323478 A1
(43) Pub. Date: Oct. 16, 2025

(54) BRACKET ASSEMBLIES FOR COMMUNICATION CABLES

(71) Applicant: ABB Schweiz AG, Baden (CH)

(72) Inventors: Daniel Lalancette, Saint-Jean-Sur-Richelieu (CA); Yves Boucher, Saint-Jean-Sur-Richelieu (CA)

(21) Appl. No.: 19/098,627

(22) Filed: Apr. 2, 2025

(30) Foreign Application Priority Data
Apr. 16, 2024 (CA) 3235280

(51) Int. Cl. H02G 3/04; F16L 3/06; F16L 3/12; F16L 3/127; F16L 3/23; H02G 3/36

(52) U.S. Cl. CPC H02G 3/0456; F16L 3/06; F16L 3/1222; F16L 3/127; F16L 3/23; H02G 3/36

(57) ABSTRACT

A bracket assembly for providing electrical connections with communication cables is provided. The bracket assembly includes a connection plate shaped to be mounted on a stud of a building, and a cable bracket extending from the connection plate and configured to provide electrical connections with communication cables. The cable bracket includes a frame, and a cable holder extending from the frame and including one or more fingers configured to hold one or more communication cables in a tool-free manner.

### BACKGROUND

The field of the disclosure relates generally to electrical power delivery, and more particularly, to bracket assemblies for providing electrical connections to communication cables.

In a building, electrical connections to communication cables are needed. The connections to communication cables are provided at an outlet for communication cables. When communication cables are located distant from an electrical box for providing electrical connections with power utility, the electrical box is unavailable to be used as a substitute of an outlet. Known bracket assemblies for providing access to the communication cables are disadvantaged in some aspects and improvements are desired.

### BRIEF DESCRIPTION

In one aspect, a bracket assembly for providing electrical connections with communication cables is provided. The bracket assembly includes a connection plate shaped to be mounted on a stud of a building, and a cable bracket extending from the connection plate and configured to provide electrical connections with communication cables. The cable bracket includes a frame including a plurality of sides, and a cable holder. The cable holder is in a shape resembling letter E. The cable holder includes an arm extending from a side of the plurality of sides, and a plurality of fingers extending from the arm at non-zero angles with the arm. The fingers and the arm define a plurality of finger apertures sized to receive one or more communication cables therethrough.

In another aspect, a bracket assembly for providing electrical connections with communication cables is provided. The bracket assembly includes a connection plate shaped to be mounted on a stud of a building, and a cable bracket extending from the connection plate and configured to provide electrical connections with communication cables. The cable bracket includes a frame, and a cable holder extending from the frame and including one or more fingers configured to hold one or more communication cables in a tool-free manner.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1A is a perspective view of an example bracket assembly installed on a stud.

FIG. 1B is a top view of the assembly shown in FIG. 1A.

FIG. 1C is a side view of the assembly shown in FIG. 1A.

FIG. 1D is a rear view of the assembly shown in FIG. 1A.

FIG. 1E is a front view of the assembly shown in FIG. 1A.

FIG. 2A is a top perspective of the bracket assembly shown in FIG. 1A, where the cable holder of the bracket assembly is in a folded position.

FIG. 2B is a bottom perspective of the bracket assembly shown in FIG. 2A.

FIG. 2C is a top view of the bracket assembly shown in FIG. 2A.

FIG. 2D is a bottom view of the bracket assembly shown in FIG. 2A.

FIG. 3A is a top perspective of the bracket assembly shown in FIG. 2A when the cable holder is in an unfolded position.

FIG. 3B is a bottom perspective view of the bracket assembly shown in FIG. 3A.

FIG. 3C is a top view of the bracket assembly shown in FIG. 3A.

FIG. 3D is a bottom view of the bracket assembly shown in FIG. 3A.

FIG. 4A is a perspective view of another example bracket assembly.

FIG. 4B shows cables are coupled with the bracket assembly shown in FIG. 4A.

FIG. 5A is a perspective view of one more example bracket assembly.

FIG. 5B is a top view of the bracket assembly shown in FIG. 5A.

FIG. 5C is a side view of the bracket assembly shown in FIG. 5A.

FIG. 5D is a front view of the bracket assembly shown in FIG. 5A.

FIG. 6A is a perspective view of one more example bracket assembly.

FIG. 6B is a top view of the bracket assembly shown in FIG. 6A.

FIG. 6C is a side view of the bracket assembly shown in FIG. 6A.

FIG. 6D is a front view of the bracket assembly shown in FIG. 6A.

FIG. 7A is a perspective view of one more example bracket assembly.

FIG. 7B is a top view of the bracket assembly shown in FIG. 7A.

FIG. 7C is a side view of the bracket assembly shown in FIG. 7A.

FIG. 7D is a front view of the bracket assembly shown in FIG. 7A.

FIG. 7E is a top view of the bracket assembly shown in FIG. 7A, where the bracket assembly is coupled with a cable.

FIG. 7F is a side view of the assembly shown in FIG. 7E.

FIG. 8A is a perspective view of one more example bracket assembly.

FIG. 8B is a top view of the bracket assembly shown in FIG. 8A.

FIG. 8C is a side view of the bracket assembly shown in FIG. 8A.

FIG. 8D is a front view of the bracket assembly shown in FIG. 8A.

FIG. 8E is a top view of the bracket assembly shown in FIG. 8A, where the bracket assembly is coupled with a cable.

FIG. 8F is a side view of the assembly shown in FIG. 8E.

FIG. 9A is a perspective view of one more example bracket assembly.

FIG. 9B is a top view of the bracket assembly shown in FIG. 9A.

FIG. 9C is a side view of the bracket assembly shown in FIG. 9A.

FIG. 9D is a front view of the bracket assembly shown in FIG. 9A.

FIG. 10A shows that one of the fingers of the bracket assembly illustrated in FIG. 9A is coupled with a cable.

FIG. 10B shows two fingers of the bracket assembly shown in FIG. 9A is coupled with a cable.

FIG. 11A is a perspective view of one more example bracket assembly.

FIG. 11B is a top view of the bracket assembly shown in FIG. 11A.

FIG. 11C is a side view of the bracket assembly shown in FIG. 11A.

FIG. 11D is a front view of the bracket assembly shown in FIG. 11A.

### DETAILED DESCRIPTION

The disclosure includes bracket assemblies and methods of assembling bracket assemblies. Method aspects will be in part apparent and in part explicitly discussed in the following description.

In a building, an outlet or a bracket assembly is needed for establishing electrical connections with communication cables, such as Internet or coaxial cables, in providing communication to the building. An electrical box may be not nearby to be used as a substitute of a bracket assembly. Therefore, a bracket assembly needs to be separately provided and installed on a stud of the building.

Known bracket assemblies have at least some of the following drawbacks. Some known bracket assemblies are not configured to be installed on a stud, and are instead configured to be mounted only on a dry wall. Attachment to a dry wall tends to be unstable and may cause damage to the dry wall. Some known bracket assemblies are not configured to hold cables in place such that the cables can be easily accessible to a field worker. A dry wall is typically installed over the bracket assembly. To access the cables for providing communication, the field worker needs to fumble behind the dry wall if the cables are not held in place by the bracket assembly, which may be challenging due to the limited size of the aperture provided by the bracket assembly. In some known bracket assemblies, a tool, such as a plier, is required to hold the cables with or remove the cables from the bracket assembly. Such a process is time consuming and tedious. The tool may damage the cables or the casings of the cables, resulting in impairment to the performance of the cables. In some known bracket assemblies, the bracket assembly does not provide a pocket deep enough to receive the cables and/or an adapter of the cables such that cutting the dry wall in the front may cut the cables and/or the adapter.

In contrast, the assemblies and methods disclosed herein address the above problems in known bracket assemblies. The bracket assemblies disclosed herein facilitate stable installations with a stud. A one-fastener installation, where the bracket assembly may be installed via only one fastener, is available to reduce the complexity in assembling and costs from labor.

The bracket assemblies described herein include cable holders to hold the cables in place, providing a field worker with an easy access of the cables such that the field worker does not need to fumble behind the dry wall to locate the cables. Holding the cables with and removing the cables from the bracket assembly is quick and easy. To hold the cables with the bracket assembly, the cables are inserted through finger apertures or wrapped by fingers. To remove the cables from the bracket assembly, the cables are slid out of the finger apertures or unwrapped from the fingers. Holding and removing the cables may be tool-free, where a tool is not needed to hold the cables with the bracket assembly or remove the cables from the bracket assembly. The hold on the cables is secure due to the zigzagged pattern of the finger apertures or the wrapping by the fingers. A cable holder of the bracket assembly may be in a folded position or an unfolded position. When in an unfolded position, the cables are away from the frame aperture, thereby avoiding accidental damage to the cables from cutting the dry wall. In some embodiments, a pocket behind the frame of the bracket assembly is provided. The depth of the pocket is greater than a thickness of a dry wall such that cables and/or an adapter of the cables may be received in the pocket and the cutting of the dry wall does not accidentally damage the cables and/or the adapter.

The bracket assemblies disclosed herein are fabricated using an embossing mechanism and include embossed features to increase the strength of the bracket assemblies while facilitating reduced thickness of the material for the bracket assembly, thereby reducing the material costs of the bracket assemblies and/or increasing the strength of the bracket assemblies and the durability of the installation.

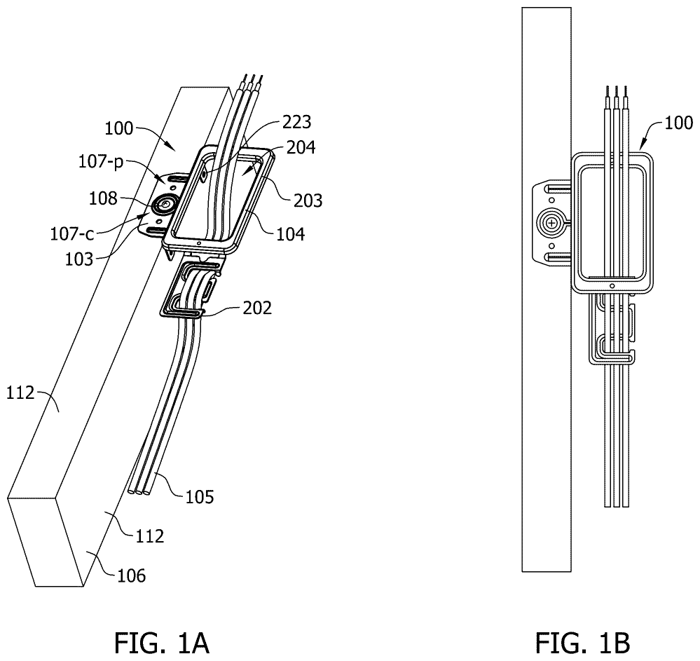

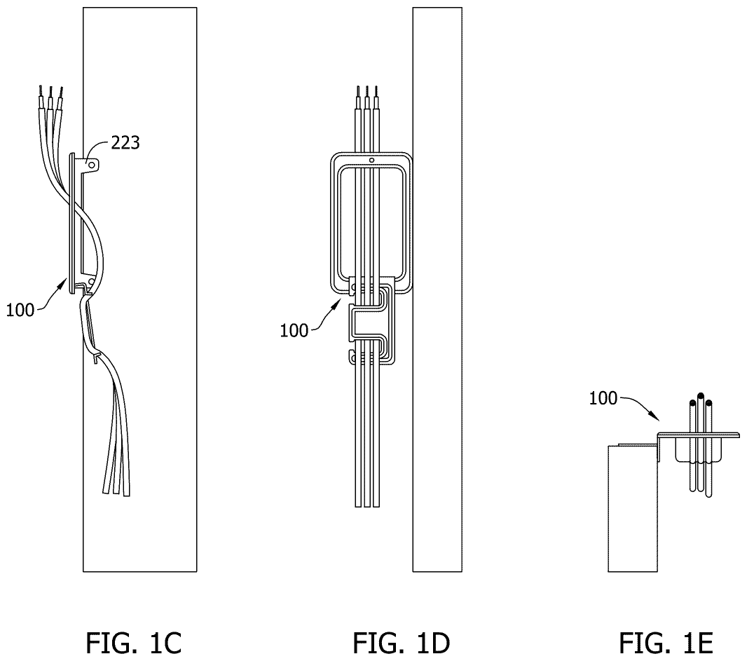

FIGS. 1A-1E show an example bracket assembly 100 installed on a stud 106. FIG. 1A is a perspective view of the bracket assembly 100 installed on the stud 106. FIG. 1B is a top view of the assembly shown in FIG. 1A. FIG. 1C is a right side view of the assembly shown in FIG. 1A. FIG. 1D is a rear view of the assembly shown in FIG. 1A. FIG. 1E is a front view of the assembly shown in FIG. 1A.

In the example embodiment, the bracket assembly 100 includes a connection plate 103 and a cable bracket 104. The cable bracket 104 is configured to provide electrical connections with communication cables 105. The connection plate 103 is shaped to be mounted on a stud 106 of a building. The stud 106 may be metallic or wooden. The connection plate 103 defines one or more plate apertures 107 each sized to receive a fastener 108 therethrough. The connection plate 103 and the cable bracket 104 may be formed as one single unit. Alternatively, the connection plate 103 and the cable bracket 104 are separate pieces and are coupled with one another via coupling mechanisms, such as welding or fastening with fasteners.

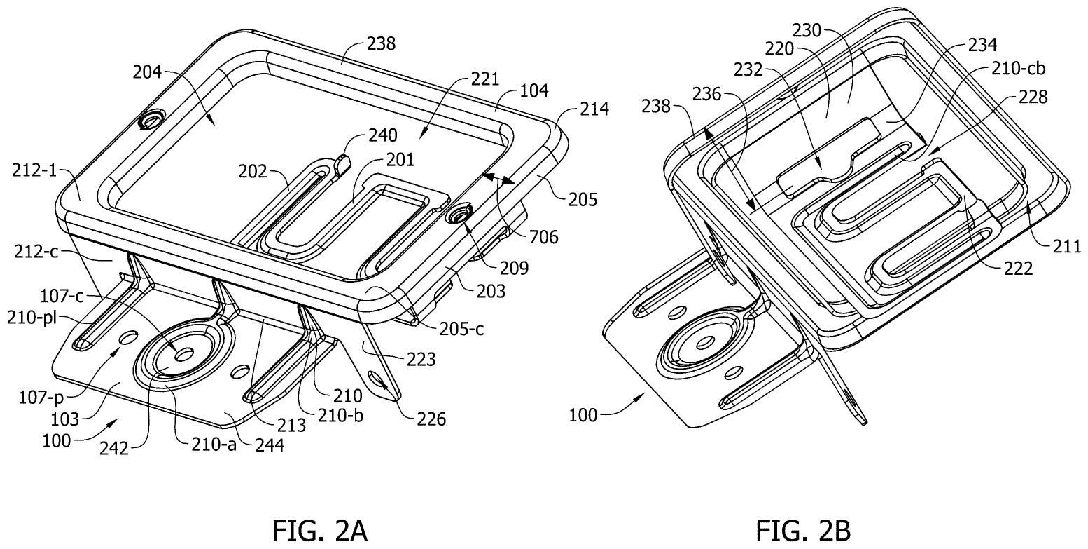

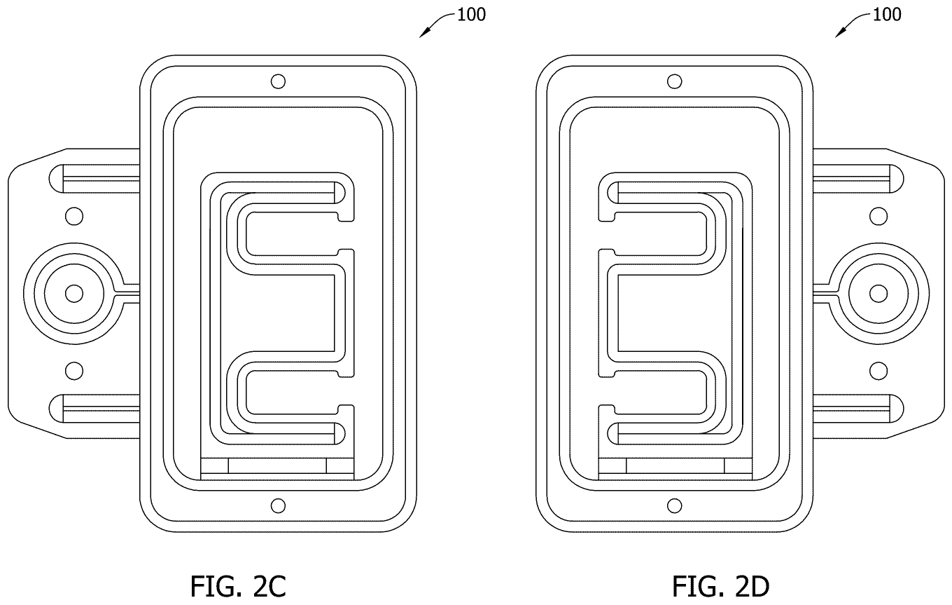

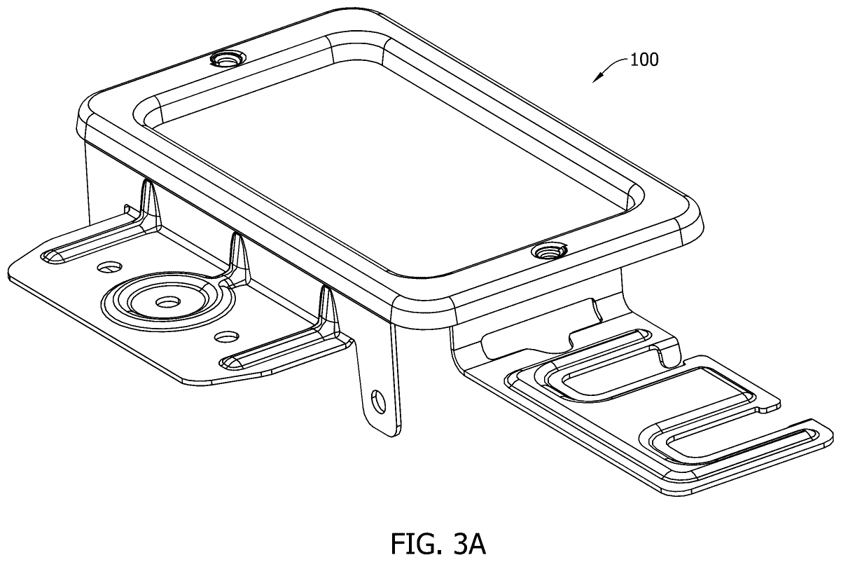

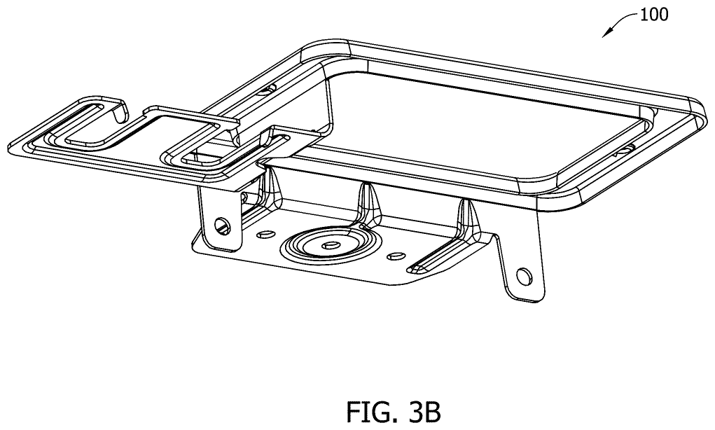

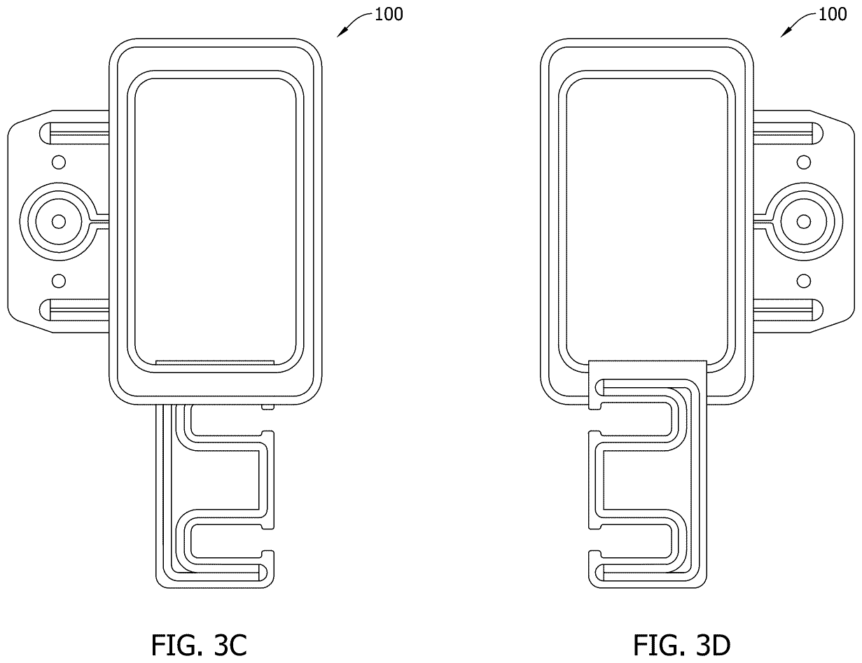

FIGS. 2A-3D show the bracket assembly 100 by itself. FIGS. 2A-2D show the bracket assembly 100 in a folded position. FIGS. 3A-3D show the bracket assembly 100 in an unfolded position. FIGS. 2A and 3A are top perspective views of the bracket assembly. FIGS. 2B and 3B are bottom perspective views. FIGS. 2C and 3C are top views. FIGS. 2D and 3D are bottom views.

In the example embodiment, the bracket assembly 100 includes the connection plate 103 and the cable bracket 104. The cable bracket 104 includes a frame 203. The frame 203 may be in a shape of a rectangle. The frame 203 may be in other shapes, such as a polygon, that enable the frame 203 to function as described herein. The frame 203 defines a frame aperture 204. Communication cables 105 may be retrieved through the frame aperture 204 in establishing connections for communication (see FIGS. 1A-1E). The frame 203 includes one or more sides 205. The sides 205 form the shape of the frame 203. The side 205 may define a side aperture 209 sized to receive a fastener for fastening a finishing plate (not shown) to cover the frame 203 and the frame aperture 204. Any number of side apertures 209 may be defined in any side 205 or any number of sides 205 to enable the bracket assembly 100 to function as described herein. In the depicted embodiment, a corner 214, where two neighboring sides 205 intersect, is rounded. A rounded corner 214 is advantageous in facilitating cutting of a dry wall by providing space by the rounded corner 214 for maneuvering of a cutting tool of the dry wall.

In the example embodiment, one of the sides 205 may be a connection side 205-c that connects the cable bracket 104 with the connection plate 103. The connection side 205-c may include a first surface 212-1 and a connection surface 212-c extending at a non-zero angle with the first surface 212-1. The connection surface 212-c intersects the connection plate 103 at a bracket edge 213. The connection surface 212-c may further include one or more legs 223. The legs 223 are positioned at the ends of the connection side 205-c. The legs 223 may be positioned at opposite sides of the connection plate 103 from the first surface 212-1. A leg aperture 226 is defined in a leg 223 and sized to receive a fastener (not shown) to fasten the leg 223 with the stud 106, thereby increasing the strength of coupling between the bracket assembly 100 and the stud 106.

In the example embodiment, the cable bracket 104 includes a cable holder 202 extending from the frame 203 at one or more sides 205. The cable holder 202 is configured to hold communication cables 105 (see FIGS. 1A-1E). The cable holder 202 may be in a folded position (see FIGS. 2A-2D), where the cable holder 202 extends toward one or more sides 205. The cable holder 202 may be in an unfold position (see FIGS. 1A-1E and 3A-3D), where the cable holder 202 extends away from the frame 203 and the sides 205 of the frame 203. In use, the cable holder 202 may be in a folded position or an unfolded position. The cable holder 202 may be manufactured and shipped in a folded positioned.

In the example embodiment, the cable holder 202 includes an arm 220 extending from the frame 203. One or more fingers 222 extends from the arm 220. The finger 222 extends in a direction forming a non-zero angle with the extending direction of the arm 220. In depicted embodiment, the fingers 222 extend approximately perpendicularly from the arm 220. The fingers 222 and the arm 220 define one or more elongated finger apertures 228 sized to receive one or more communication cables 105 (see FIGS. 1A-1E) therethrough. A finger aperture 228 may be between neighboring fingers 222 or between a finger 222 and the arm 220. The cable holder 202 may be formed into a shape resembling letter E. Finger edges 201 bordering the finger aperture 228 may be at an approximately right angle with the arm 220 to increase the space of the finger aperture 228 and restriction of movement of the cables 105.

During construction, the bracket assembly 100 may be installed onto a stud 106, and then a dry wall is placed over. An aperture is cut in the dry wall to expose the frame 203 of the bracket assembly 100. A finishing plate (not shown) is then installed over and cover the frame 203.

In the example embodiment, the arm 220 extends deeper into the frame aperture 204 and away from the frame 203 before curving back toward a side 205 in a folded position (see FIGS. 2A and 2B) or away from a side in an unfolded position (see FIGS. 3A and 3B). The arm 220 includes an arm base 230 and defines an arm aperture 232 such that the width of the arm 220 is reduced at the area by the arm aperture 232, thereby weakening the arm 220 at the arm aperture 232 and facilitating bending at a bending point 234 by the arm aperture 232. Therefore, to unfold or fold the cable bracket 104, the cable bracket 104 is bent at the bending point 234. The bending depth 236 of the cable bracket 104 may be at least greater than a thickness of a dry wall, where the bending depth 236 is the depth of the arm at the bending point 234 from the top surface 238 of the frame 203. As a result, cutting of the dry wall to create an aperture to expose the frame 203 does not accidentally damage the cables and/or the adapter, even when the cable holder 202 is in a folded position.

In the example embodiment, the finger 222 further includes a protuberance 240 at an end of the finger 222 and/or the arm 220. The protuberance 240 restricts a cable from sliding out of the finger aperture.

When the cable holder 202 is in the unfolded position, the cables 105 are positioned away from the frame 203 and out of the way from cutting of the dry wall, thereby avoiding accidental damage to the cables 105 from cutting the dry wall. Therefore, when the cable holder 202 is in an unfolded position, a pocket 221 does not need to be deeper than the thickness of the dry wall in order to avoid the cutting of the cables 105.

In operation, to hold one or more cables 105 in the cable holder 202, cables 105 are slid into and out of a first finger aperture 228 and then slid into and out of a second finger aperture 228 (see FIGS. 1A-1E). The protuberances 240 resist the cables 105 from dislocating out of the finger apertures 228. Further, because the cables 105 go in and out of the finger apertures in a zigzagged pattern (see FIGS. 1B and 1C), the fingers 222 press on and hold the cables 105 with the cable holder 202. To remove the cables 105 from the cable holder 202, the cables 105 are slid out of one finger aperture 228 at a time.

In the example embodiment, the connection plate 103 defines one or more plate apertures 107. The plate aperture 107-c may be positioned at a center area 242 of the connection plate 103. The plate apertures 107-p may be positioned at a periphery 244 of the connection plate 103. The bracket assembly 100 may be installed onto a stud 106 at the center plate aperture 107-c or the peripheral plate apertures 107-p (see FGs. 1A-1D). The center plate aperture 107-c facilitates a one-fastener installation. Fasteners 108 may be received in peripheral plate apertures 107-p such that the fasteners 108 are as far apart as prided by the connection plate 103 to increase the strength of hold with the stud 106 while increasing the number of fasteners, which also increases the strength of hold.

In the example embodiment, the angle between the connection plate 103 and the connection surface 212-c of the connection side 205 may be approximately 90°, where the connection plate 103 and the connection surface 212-c are approximately perpendicular with one another. As a result, when placed on the stud 106, the bracket assembly 100 has the connection plate 103 and the legs 223 aligned along neighboring faces 112 of the stud 106, thereby increasing the ease and stability of installation (see FIGS. 1A-1E).

In the example embodiment, the bracket assembly 100 includes ridges 210 to increase the strength of the bracket assembly 100. Ridges 210 may be formed by shaping the bracket assembly 100 into the shapes of the ridges 210 or grooves 211 at the opposite side of the ridges 210. The ridges 210 are at non-zero angles with a bending force of the ridges 210, thereby increasing the strength of the bracket assembly 100 and facilitating a reduced thickness of material and costs of the assembly. The bracket assembly 100 may include bracket ridges 210-b and/or plate ridges 210-p1. The bracket ridges 210-b are positioned along the bracket edge 213. The bracket ridges 210-b are at non-zero angles with the bracket edge 213. The bending of the connection plate 103 and/or the cable bracket 104 along the bracket edge 213 is resisted by the bracket ridges 210 as the extending directions of the bracket ridges 210 are not parallel or at non-zero angles with the bracket edge 213. The connection plate 103 may include one or more plate ridges 210-p1. The plate ridge 210-p1 is at a non-zero angle with the bracket edge 213 such that the bending of the connection plate 103 is resisted by the plate ridge 210-p1.

In the example embodiment, the bracket assembly 100 may further include an aperture ridge 210-a. The aperture ridge 210-a at least partially surrounds the plate aperture 107. In the depicted embodiment, the bracket ridge 210-b is connected with another ridge 210, such as an aperture ridge 210-a or a plate ridge 210-p1. In some embodiments, the ridges 210 may be separate from one another.

In some embodiments, ridges 210-cb may be formed in the cable bracket 104. For example, ridges 210 may be formed in fingers 222. Grooves 211 may be formed along sides 205. Ridges 210 may be formed in along the arm 220. The ridges 210 and/or grooves 211 strengthen the cable bracket 104 and the cable holder 202.

In at least some known bracket assemblies, stamping is used to fabricate the bracket assemblies, where a sheet metal is cut, punctured, and/or bend along lines. In contrast, in the example embodiments, the bracket assembly 100 is embossed, where at least parts of the bracket assembly 100, such as the ridges 210, are fabricated using an embossing mechanism. In embossing, the shape of the original material, such as sheet metal, is changed at some locations. Grooves 211 and/or ridges 210 may be formed by embossing. The embossed ridges 210 or grooves 211 are at non-zero angles with bending forces of the ridges 210 or grooves 211, thereby increasing the strength of the bracket assembly 100 and facilitating a reduced thickness of material and reduced costs of the bracket assembly 100.

In some embodiments, the ridges 210 are formed by molding. The material of the connection plate 103 and/or the cable bracket 104 may be plastic.

Referring back to FIGS. 1A-1E, in operation, to install the bracket assembly 100 onto the stud 106, the connection plate 103 is positioned over a face 112 of the stud 106 with the cable bracket 104 at a side of the stud 106. Fasteners 108 are inserted into the plate apertures 107 and fasten the connection plate 103 with the stud 106. In some embodiments, the coupling between the bracket assembly 100 and the stud 106 is strengthened by fastening the legs 223 to the stud 106. The legs 223 are coupled with the stud 106 at a different face 112 of the stud 106 from the connection plate 103. The connection plate 103 may be perpendicular or at a right angle with the connection surface 212-c such that the legs 223 align with a face 112 of the stud 106 and the connection plate 103 or at least a portion of the connection plate 103 aligns with a neighboring face 112 of the stud 106, thereby increasing the convenience and the strength of the coupling between the bracket assembly 100 and the stud 106.

Further, communication cables 105 may be positioned in and held by the cable holder 202 such that the field worker does not need to fumble behind the frame 203 and/or the dry wall (not shown) to retrieve the communication cables 105, which may be challenging because the size of the frame aperture 204 provided by the frame 203 is limited.

FIGS. 4A and 4B show another example bracket assembly 100-4. The cable holder 202 of the bracket assembly 100-4 has a shape resembling letter E. FIG. 4A is a perspective view of the bracket assembly 100-4. FIG. 4B shows that the bracket assembly 100-4 is coupled with cables 105. Compared to the bracket assembly 100 shown in FIGS. 1A-3D, the connection plate 103 defines two apertures and does not include a center plate aperture 107-c. To couple the bracket assembly 100-4 with the stud 106, two fasteners are used to fasten the connection plate 103 with the stud 106.

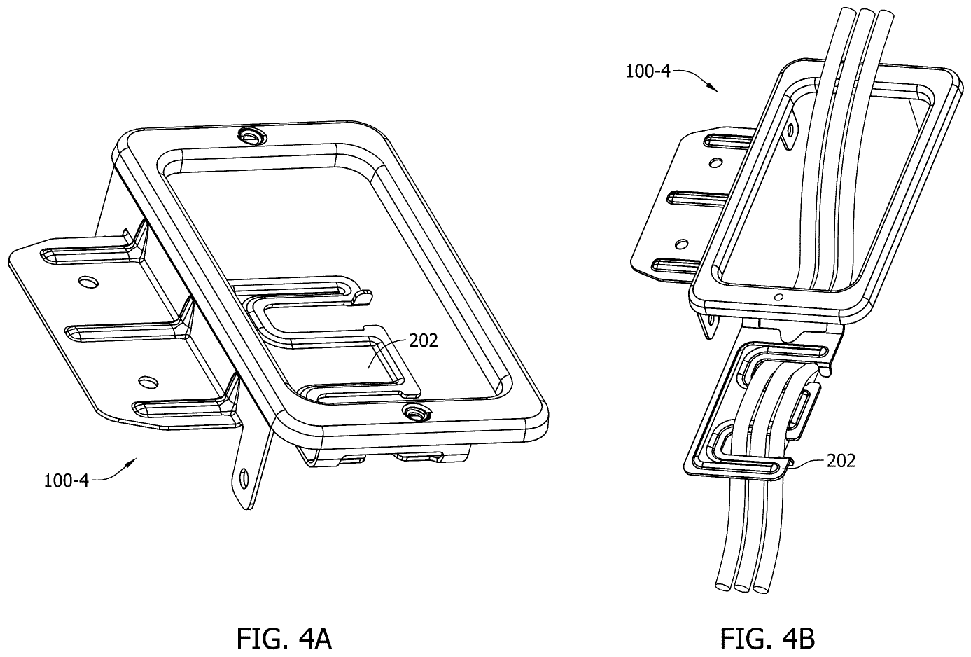

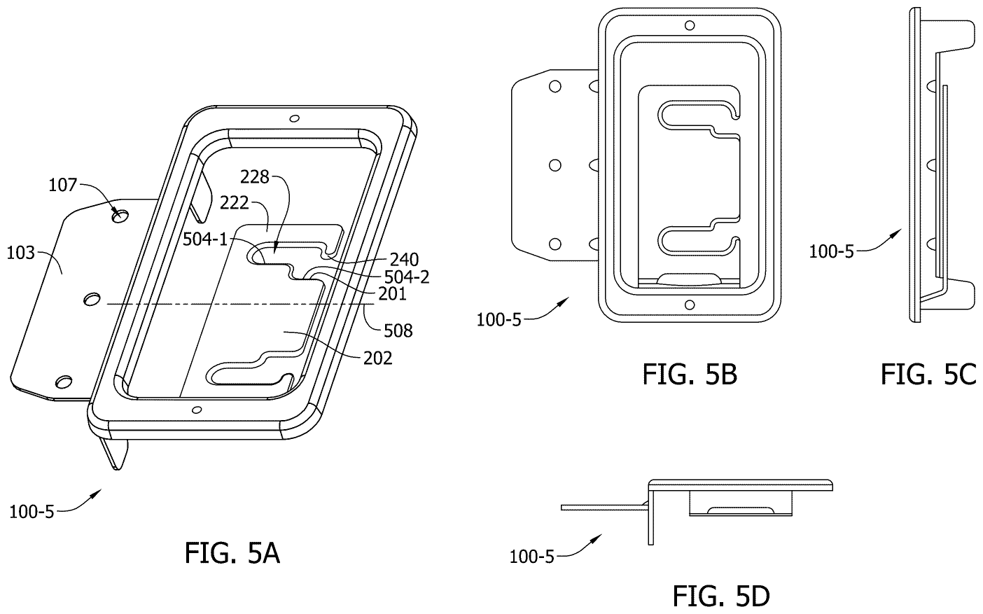

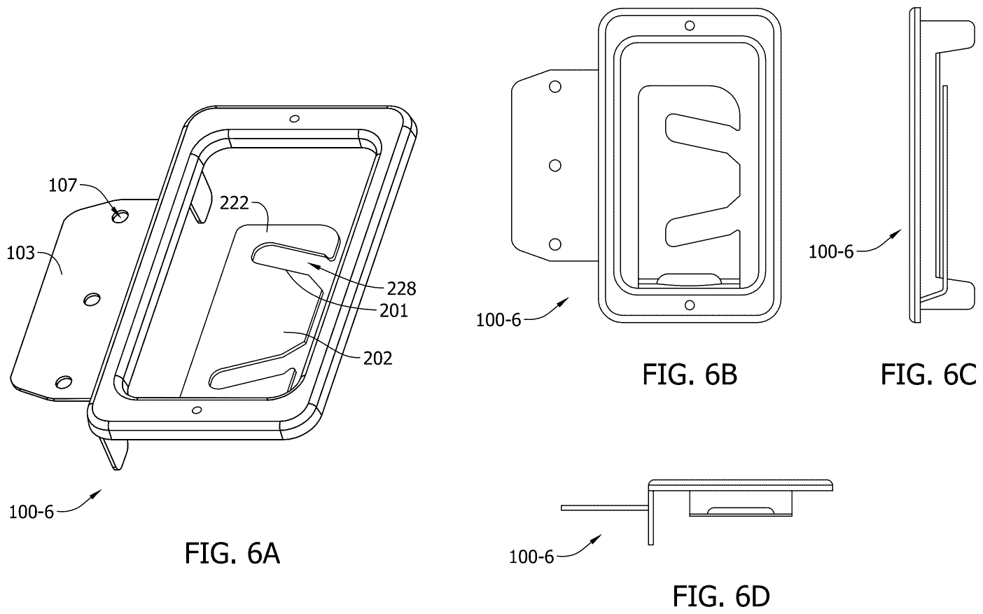

FIGS. 5A-6D show two more example bracket assemblies 100-5, 100-6. The cable holder 202 of the bracket assembly 100-5, 100-6 is in a shape resembling letter E. FIGS. 5A and 6A are perspective views of the bracket assemblies 100-5, 100-6. FIGS. 5B and 6B are tope views. FIGS. 5C and 6C are right side views. FIGS. 5D and 6D are front views.

In the example embodiments, the connection plate 103 defines a plurality of plate apertures 107. The bracket assembly 100 may be fastened to the stud via one or more fasteners 108 (see FIGS. 1A and 1B).

Referring to FIGS. 5A-5D, in the example embodiment, compared to the cable holder 202 shown in FIGS. 1A-4B, one of the finger edges 201 of a finger 222 is stepped and the finger apertures are stepped. The stepped finger edge 201 includes a first section 504-1 and a second section 504-2 stepping from the first section 504-1. The first section 504 may be along a radial direction 508 of the cable holder 202. The stepped second section eases the sliding a cable 105 into and out of the finger aperture 228. The protuberance 240 at the end of the finger 222 and/or the arm 220 restricts the cable 105 from sliding out the finger aperture 228.

Referring to FIGS. 6A-6D, in the example embodiment, compared to the cable holder 202 shown in FIGS. 1A-5D, the finger edge 201 of a finger 222 is sloped and the finger apertures 228 are sloped. The bracket assembly 100-6 with sloped finger apertures 228 along the sloped finger edge 201 may have reduced hold on the cables 105 (see FIGS. 1A-1E) as the cable 105 may slide out the sloped finger apertures 228 along the slope.

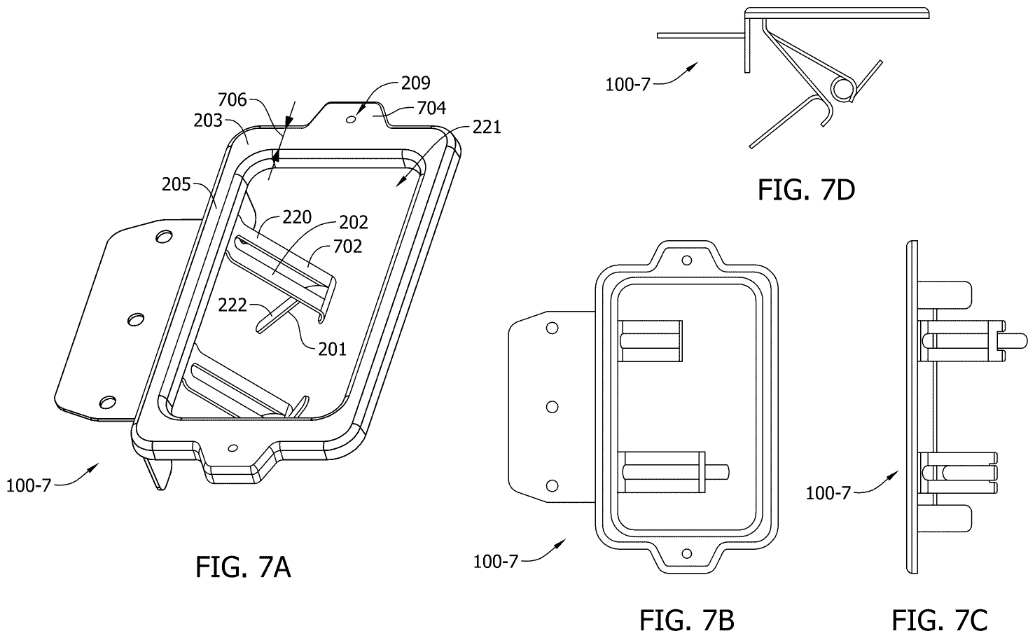

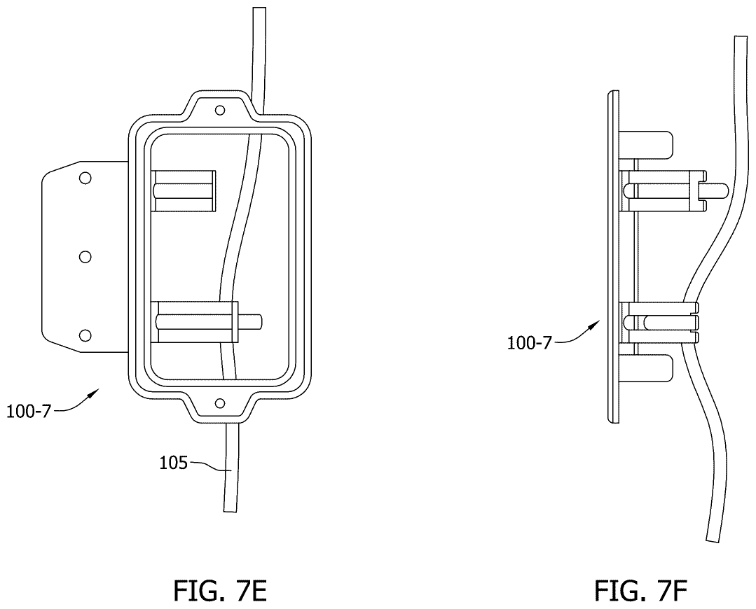

FIGS. 7A-7F show one more example bracket assembly 100-7. FIG. 7A is a perspective view of the bracket assembly 100-7. FIG. 7B is a top view of the bracket assembly 100-7. FIG. 7C is a right side view of the bracket assembly 100-7. FIG. 7D is a front view of the bracket assembly 100-7. FIG. 7E is a top view of the bracket assembly 100-7 coupled with a cable 105. FIG. 7F is a side view of the assembly shown in FIG. 7E.

In the example embodiment, the cable holder 202 includes one or more arms 220 extending from a side 205. The arms 220 extend away from the frame 203 such that the arms 220 and the frame 203 form a non-zero angle (see FIG. 7D). In the depicted embodiment, the arms 220 extend from one side 205 of the frame 203 of the cable holder 202. Alternatively or additionally, one or more arms 220 may extend from any side 205 or any number of sides 205 of the frame 203. The arm 220 includes a finger 222. The finger 222 may be formed by cutting the arm 220, which was one piece originally, along some finger edges 201 of the finger 222 while leaving the finger 222 attached with the arm 220. The finger 222 is positioned at a distal end 702 of the arm 220. The distal end 702 is distal from the side 205, from which the arm 220 extends. The lengths of the arms 220 may be such that a pocket 221 defined by the arms 220 and the frame 203 may have a depth greater than a thickness of a dry wall and cutting of the dry wall does not accidentally cut the cables 105 held by the finger 222 or an adapter connected with the cables 105.

In operation, to hold a cable 105, the finger 222 is folded. The cable 105 may be released from the hold by unfolding the finger 222. Multiple arms 220 with multiple fingers 222 increase the hold on the cable 105.

In the example embodiment, the side 205 may include a tab 704 extending outward from the frame 203. The side aperture 209 is defined in the tab 704. With tabs 704, the width 706 of the side 205 may be reduced while still accommodating the side aperture 209, compared to the width 706 of the side 205 in the bracket assembly 100, 100-4, 100-5, and 100-6. The bracket assembly 100-7 may include any number of tabs at any side 205 and/or any number of sides 205 to enable the bracket assembly 100-7 to function as described herein.

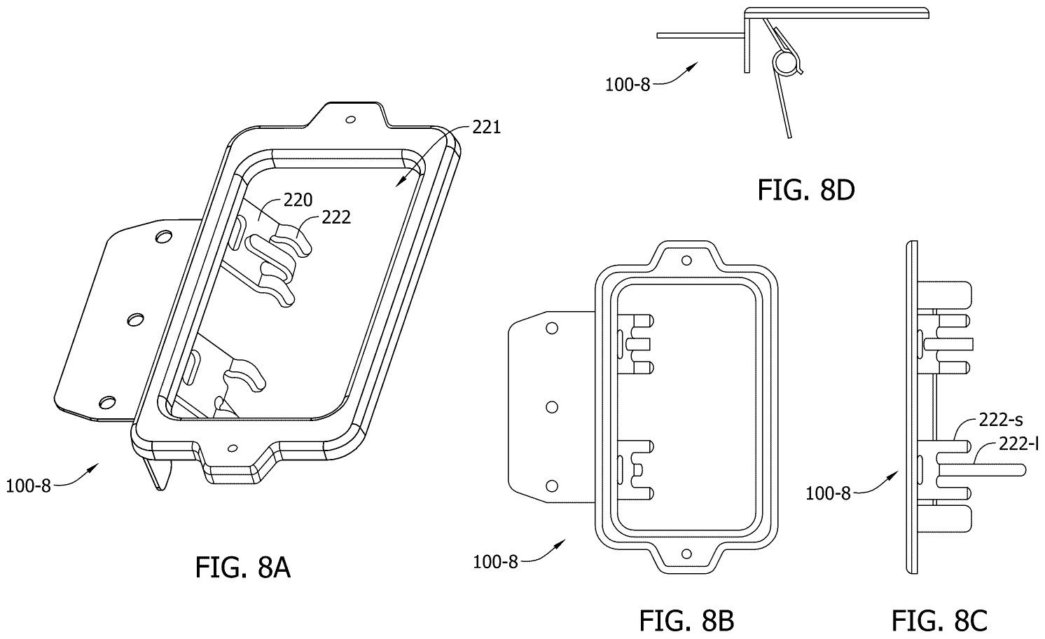

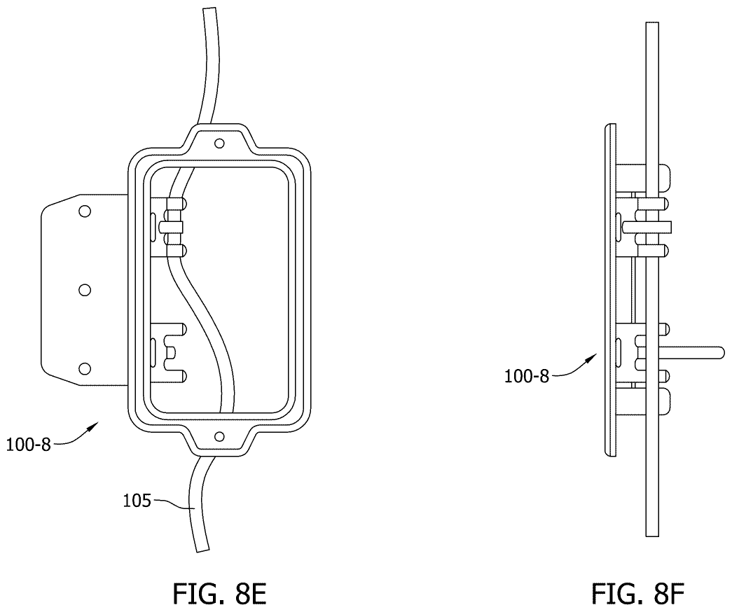

FIGS. 8A-8F show one more bracket assembly 100-8. FIG. 8A is a perspective view of the bracket assembly 100-8. FIG. 8B is a top view of the bracket assembly 100-8. FIG. 8C is a side view of the bracket assembly 100-8. FIG. 8D is a front view of the bracket assembly 100-8. FIG. 8E is a top view of the bracket assembly 100-8 coupled with a cable 105. FIG. 8F is a side view of the assembly shown in FIG. 8E.

In the example embodiment, one or more fingers 222 extend from the arm 220. The arm 220 may branch into a plurality of fingers 222. Fingers 222 includes at least one long finger 222-1 and at least one short finger 222-s, where the long finger 222-1 extends further and has a length greater than the short finger 222-s. The short fingers 222-s may be curved. The long finger 222-1 may be positioned between short fingers 222-s.

In operation, to hold the cable, the long finger 222 is folded on the cable 105. The cable 105 may be received in the curve of the short finger 222. To release the cable 105, the longer finger 222 is unfolded.

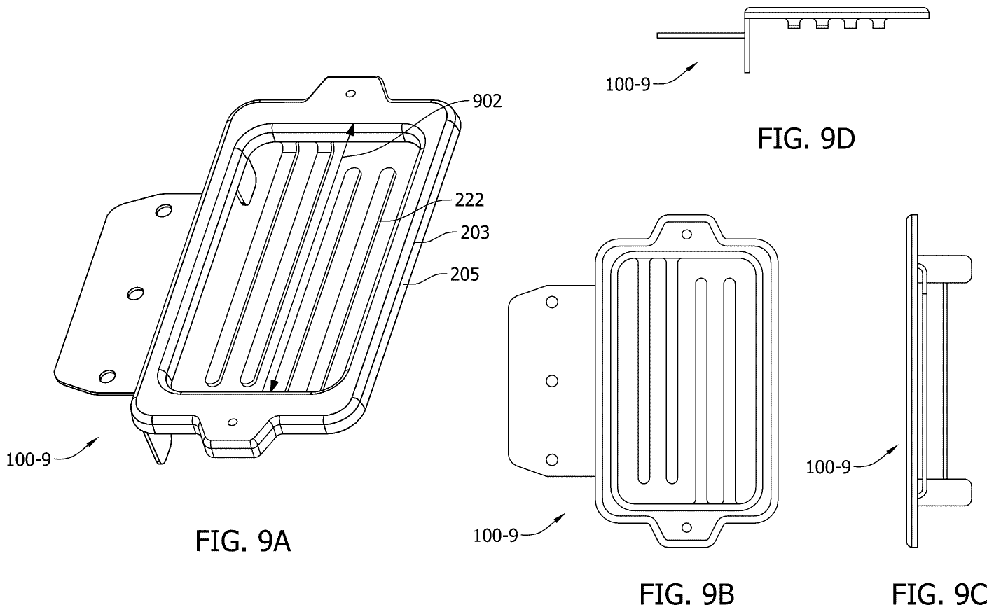

FIGS. 9A-9D show one or more example bracket assembly 100-9. FIG. 9A is a perspective view of the bracket assembly 100-9. FIG. 9B is a top view of the bracket assembly 100-9. FIG. 9C is a side view of the bracket assembly 100-9. FIG. 9D is a front view of the bracket assembly 100-9.

In the example embodiment, the fingers 222 extend directly from the sides 205 of the frame 203. The finger 222 is elongated. The finger 222 may extend along a majority of a length 902 of the frame 203, a distance between opposing sides 205. The length of a finger 222 is sized to wrap around a cable in at least one loop. In the depicted embodiment, pairs of fingers 222 extend from opposite sides 205 of the frame 203. Any number of fingers 222 may extend from any side 205 or any number of sides of the frame 203 to enable the bracket assembly 100 to function as described herein. A pair of fingers 222 may be used together to tie around one or more cables 105.

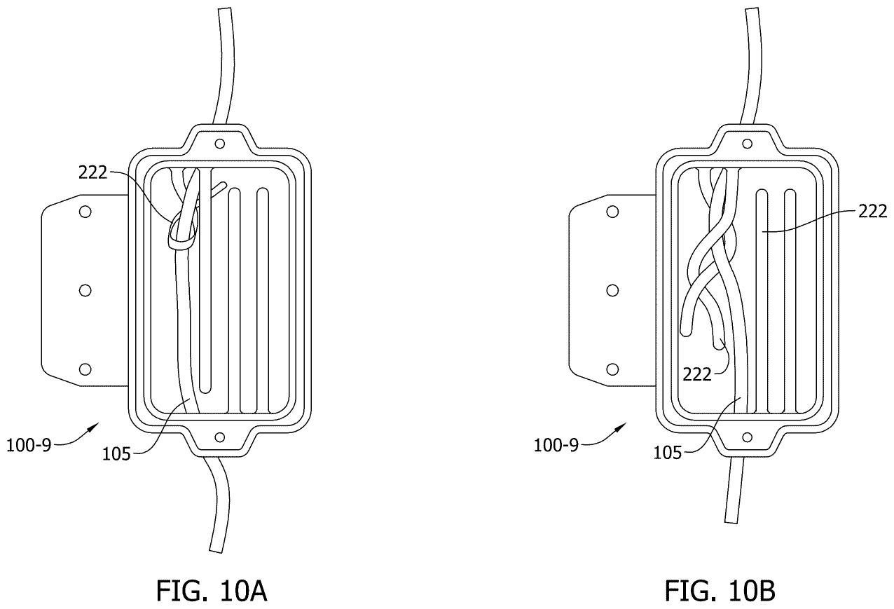

FIGS. 10A and 10B show the coupling of the fingers 222 with a cable 105. FIG. 10A shows that one finger 222 is used to tie a cable 105. FIG. 10B shows two fingers 222 are used to tie one cable 105. An installer may use any number of fingers to tie any number of cables 105. For example, one finger 222 may be used to tie a plurality of cables 105.

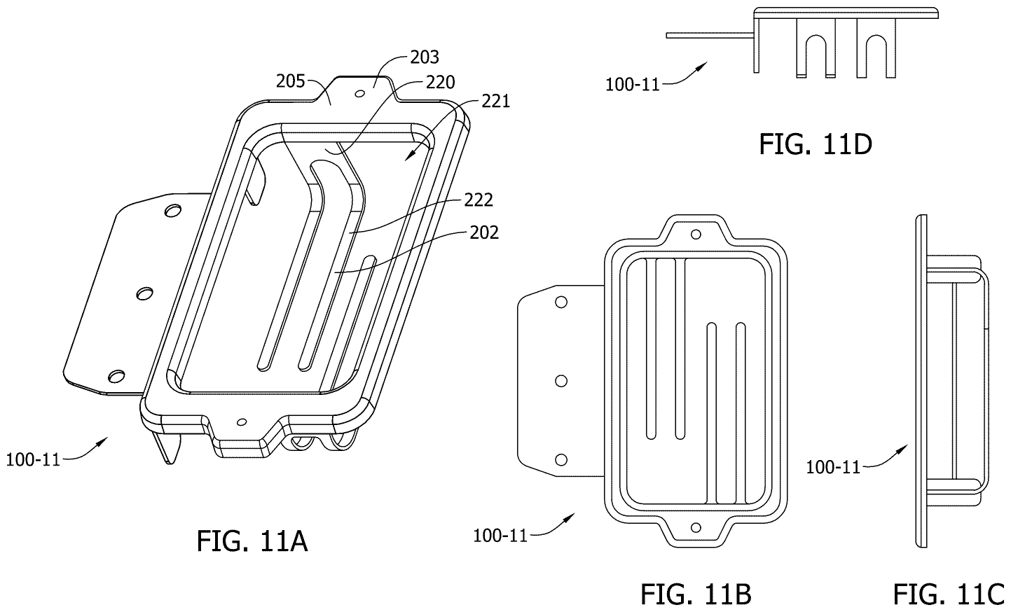

FIGS. 11A-11D show one more bracket assembly 100-11. FIG. 11A is a perspective view of the bracket assembly 100-11. FIG. 11B is a top view of the bracket assembly 100-11. FIG. 11C is a side view of the bracket assembly 100-11. FIG. 11D is a front view of the bracket assembly 100-11.

In the example embodiment, compared to the bracket assembly 100-9 shown in FIGS. 9A-9D, where the fingers extend directly from the side 205, the fingers 222 of the bracket assembly 100-11 extend from one or more arms 220. In the depicted example, two fingers 222 extend from one arm 220 and the arms 220 extend from opposite sides 205 of the frame 203. Any number of fingers 222 may extend from an arm 220, and any number of arms 220 may extend from any side 205 or any number of sides of the frame 203 to enable the bracket assembly 100-9 to function as described herein. The arms 220 extend away from the frame 203 and further into the interior of the wall. The fingers 222 first extend in a direction generally the same as the extending direction of the arm 220 and then curve around and toward a side 205 opposite to the side 205 from which the arm 220 extends. As a result, the arms 220 and the fingers 222 define a pocket 221 sized to receive cables 105 and an adapter (not shown) therein. The pocket 221 may have a depth greater than a thickness of a dry wall. A deep pocket 221 is advantageous in providing space for cables 105 and the adapter such that the cables 105 and the adapter may be fit in the pocket 221 to increase the ease and aesthetics of installation. Further, with a deep pocket, a cutting tool of the dry wall does not accidentally cut the cables 105 and/or the adapter. Otherwise, the cables 105 and the adapter may need to be reinstalled in the building, which may be challenging after a dry wall has already been assembled on the stud 106.

The cable holders 202 described herein facilitate a tool-free assembling cables 105 with or disassembling cables 105 from the bracket assembly 100. To hold one or more cables 105 with the cable holder 202, no tool is required. Removing the cables 105 from the cable holder 202 is also tool-free, where a tool is not needed to remove cables 105 from the cable holder 202. In contrast, in known bracket assemblies, a tool, such as a plier, is needed to hold the cables with the cable holder or remove the cables from the cable holder. The tool may damage the cables or the insulating casings of the cables, potentially compromising the performance of the cables.

For example, for bracket assemblies 100, 100-4, 100-5, and 100-6, where the cable holder 202 is in a shape resembling letter E, to hold cables 105 with the cable holder 202, the cables 105 are inserted into finger apertures 228, and to remove cables 105 from the cable holder 202, cables 105 are pulled out of the finger apertures 228. For bracket assemblies 100-7, 100-8, 100-9, and 100-11, to hold cables 105 with the cable holder 202, fingers 222 are folded or wrapped around the cables 105, and to remove cables 105 from the cable holder 202, fingers 222 are unfolded or unwrapped from the cables 105.

The bracket assemblies described herein are also advantageous in providing outlets for establishing electrical connections with communication cables without the need of electrical boxes. As a result, the installation is simplified and does not require a certified electrician to install a bracket assembly in establishing communication for a building.

At least one technical effect of the systems and methods described herein includes (a) a bracket assembly configured to hold cables; (b) a cable holder in a shape resembling letter E; (c) a bracket assembly in an unfolded position; (d) ridges in the bracket assembly to increase the strength of the bracket assembly; (e) embossed ridges; (f) a bracket assembly defining a pocket deeper than a thickness of a dry wall; (g) a cable holder having one or more fingers configured to hold one or more cables; (h) a bracket assembly configured to be installed on a stud; (i) a bracket assembly that facilitates tool-free coupling of the cables with and decoupling of the cables from the bracket assembly; and (j) an embossing mechanism in assembling a bracket assembly.

Example embodiments of bracket assemblies and methods of assembling bracket assemblies are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A bracket assembly for providing electrical connections with one or more communication cables, the bracket assembly comprising:
a connection plate shaped to be mounted on a stud of a building; and
a cable bracket extending from the connection plate and configured to provide the electrical connections with the one or more communication cables, the cable bracket comprising:
a frame comprising a plurality of sides; and
a cable holder, the cable holder being in a shape resembling letter E, wherein the cable holder comprises:
an arm extending from a side of the plurality of sides; and
a plurality of fingers extending from the arm at non-zero angles with the arm, the fingers and the arm defining a plurality of finger apertures sized to receive the one or more communication cables therethrough.

2. The bracket assembly of claim 1, wherein at least one of the plurality of fingers is perpendicular with the arm.

3. The bracket assembly of claim 1, wherein the cable holder further comprises a protuberance positioned at an end of the at least one of the plurality of fingers and/or the arm.

4. The bracket assembly of claim 1, wherein the cable holder is positionable in a folded position or an unfolded position.

5. The bracket assembly of claim 1, further comprising ridges.

6. The bracket assembly of claim 1, wherein the cable holder is an unfolded position.

7. The bracket assembly of claim 6, wherein the bracket assembly is fabricated with plastic.

8. The bracket assembly of claim 1, wherein at least one of the plurality of fingers comprises a stepped finger edge bordering at least one of the plurality of finger apertures.

9. The bracket assembly of claim 1, wherein at least one of the plurality of fingers comprises a sloped finger edge bordering at least one of the plurality of finger apertures.

10. A bracket assembly for providing electrical connections with one or more communication cables, the bracket assembly comprising:
a connection plate shaped to be mounted on a stud of a building; and
a cable bracket extending from the connection plate and configured to provide the electrical connections with the one or more communication cables, the cable bracket comprising:
a frame; and
a cable holder extending from the frame and comprising one or more fingers configured to hold the one or more communication cables in a tool-free manner.

11. The bracket assembly of claim 10 further comprising one or more embossed ridges.

12. The bracket assembly of claim 10 further comprising a bracket edge positioned between the cable bracket and the connection plate, wherein the bracket assembly further comprises one or more bracket ridges positioned along the bracket edge and at non-zero angles with the bracket edge.

13. The bracket assembly of claim 10 further comprising a bracket edge positioned between the cable bracket and the connection plate, wherein the connection plate comprises one or more plate ridges positioned at non-zero angles with the bracket edge.

14. The bracket assembly of claim 10, wherein the cable holder and the frame define a pocket between the cable holder and the frame, the pocket having a depth greater than a thickness of a dry wall.

15. The bracket assembly of claim 10, wherein the frame comprises a plurality of sides, the cable holder comprising one or more arms extending from at least one of the plurality of sides, the one or more fingers extending from the one or more arms.

16. The bracket assembly of claim 15, wherein the one or more fingers extend from distal ends of the one or more arms.

17. The bracket assembly of claim 15, wherein the one or more fingers comprise at least one long finger and at least one short finger, the at least one short finger having a length shorter than the at least one long finger.

18. The bracket assembly of claim 10, wherein the frame comprises a plurality of sides, the one or more fingers extending from at least one of the plurality of sides, at least one of the one or more fingers configured to wrap around the one or more communication cables.

19. The bracket assembly of claim 10, wherein the connection plate defines a plate aperture sized to receive a fastener therethrough, the connection plate comprising an aperture ridge at least partially surrounding the plate aperture.

20. The bracket assembly of claim 10, wherein the cable bracket comprises ridges and/or grooves configured to strengthen the cable bracket.

21-22. (canceled)
